(19) United States
(12) Patent Application Publication
(10) Pub. No.: US 2017/0229747 A1
(43) Pub. Date: Aug. 10, 2017

(54) BATTERY THERMAL MANAGEMENT DEVICE AND METHOD

(71) Applicant: Samsung Electronics Co., Ltd., Suwon-si (KR)

(72) Inventors: Dae Bong JUNG, Seongnam-si (KR); Dong Kee SOHN, Seoul (KR); Tae Jung YEO, Suwon-si (KR)

(73) Assignee: Samsung Electronics Co., Ltd., Suwon-si (KR)

(21) Appl. No.: 15/422,913

(22) Filed: Feb. 2, 2017

(30) Foreign Application Priority Data
Feb. 4, 2016 (KR) 10-2016-0014355

(51) Int. Cl. H01M 10/659; H01M 10/625; H01M 10/663; B60L 11/18; H01M 10/63; H01M 10/6561; H01M 10/6567; B60H 1/00; H01M 10/613; H01M 10/658

(52) U.S. Cl. CPC H01M 10/659; H01M 10/613; H01M 10/625; H01M 10/663; H01M 10/658; H01M 10/63; H01M 10/6561; H01M 10/6567; B60H 1/00278; B60H 1/00764; B60L 11/1874; H01M 2220/20; B60H 2001/003; B60H 2001/00307

(57) ABSTRACT

Disclosed are a battery thermal management method and device. The battery thermal management device includes a first thermal manager configured to regulate a battery temperature using a liquid working fluid, a second thermal manager configured to regulate the battery temperature using a gaseous working fluid, and the second thermal manager works with the first thermal manager by exchanging heat between the liquid working fluid and the gaseous working fluid.

### CROSS-REFERENCE TO RELATED APPLICATION(S)

This application claims the benefit under 35 U.S.C. §119(a) of Korean Patent Application No. 10-2016-0014355, filed on Feb. 4, 2016, in the Korean Intellectual Property Office, the entire disclosure of which is incorporated herein by reference for all purposes.

### BACKGROUND

1. Field

The following description relates to a battery thermal management device and method.

2. Description of Related Art

As environmental concerns and diminishing energy resource become more prominent, attention is being paid to electric vehicles as a future means of transportation. Electric vehicles use a battery including chargeable/dischargeable secondary cells in one pack as a main power source and thus do not emit an exhaust gas and make less noise.

A battery used as a main power source of a vehicle is frequently charged and discharged as the vehicle is accelerated and decelerated, and the intensity of charging/discharging power is high. Thus, the battery generates a lot of heat. The performance of the battery is also influenced by its temperature. Thus, it is desirable to maintain a uniform the temperature and a temperature distribution of the battery.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In one general aspect, there is provided a battery thermal management device including a first thermal manager configured to regulate a battery temperature using a liquid working fluid, and a second thermal manager configured to regulate the battery temperature using a gaseous working fluid, wherein the second thermal manager works with the first thermal manager by exchanging heat between the liquid working fluid and the gaseous working fluid.

A flow channel for the liquid working fluid may connect the first thermal manager to the powertrain cooling device.

The second thermal manager may be configured to use a gaseous working fluid heated or cooled by a heating, ventilation, and air-conditioning (HVAC) device.

The first thermal manager may include a storage tank configured to store the liquid working fluid.

The second thermal manager may include a heat exchanger provided in the storage tank, the heat exchanger being configured to exchange heat between the liquid working fluid and the gaseous working fluid.

The storage tank may be configured to be a heat insulator.

The storage tank may include a heater configured to heat the liquid working fluid.

The storage tank may include a third heat exchanger configured to exchange heat between an exhaust gas of an engine and any one or any combination of the gaseous working fluid and the liquid working fluid.

A flow channel for the liquid working fluid may be excluded from portions of the battery with likelihood of being short-circuited, and a flow channel of the gaseous working fluid is provided all portions of the battery.

The first thermal manager may be configured to block the liquid working fluid flowing from a powertrain cooling device and to cool the battery using a heat-exchanged liquid working fluid, and the second thermal manager may be configured to exchange heat between an external gaseous working fluid and the liquid working fluid and to cool the battery using the heat-exchanged external gaseous working fluid, in response to a temperature of the battery being greater than or equal to a first temperature and less than a third temperature and an external temperature being less than a second temperature.

The first thermal manager may be configured to block the liquid working fluid flowing from a powertrain cooling device and to cool the battery using a heat-exchanged liquid working fluid, and the second thermal manager may be configured to exchange heat between the gaseous working fluid cooled by a heating, ventilation, and air-conditioning (HVAC) device and the liquid working fluid and to cool the battery using the heat-exchanged gaseous working fluid, in response to a temperature of the battery being greater than or equal to a first temperature and less than a third temperature and an external temperature being greater than or equal to a second temperature.

The first thermal manager may be configured to allow the liquid working fluid from a powertrain cooling device and to heat the battery using a heat-exchanged liquid working fluid, and the second thermal manager may be configured to exchange heat between the liquid working fluid from the powertrain cooling device and the gaseous working fluid heated by a heating, ventilation, and air-conditioning (HVAC) device and to heat the battery using the heat-exchanged gaseous working fluid heated by the HVAC device, when a temperature of the battery is less than a first temperature and an external temperature being less than a second temperature.

The first thermal manager may be configured to allow the liquid working fluid from a powertrain cooling device and to heat the battery using a heat-exchanged liquid working fluid, and the second thermal manager may be configured to exchange heat between the liquid working fluid from the powertrain cooling device and an external gaseous working fluid and to heat the battery using the heat-exchanged external gaseous working fluid, in response to a temperature of the battery being less than a first temperature and an external temperature being greater than or equal to a second temperature.

The first thermal manager may be configured to block the liquid working fluid from a powertrain cooling device and to cool the battery using a heat-exchanged liquid working fluid, and the second thermal manager may be configured to exchange heat between the gaseous working fluid cooled by a heating, ventilation, and air-conditioning (HVAC) device and the liquid working fluid and to cool the battery using the heat-exchanged gaseous working fluid cooled by the HVAC, in response to a temperature of the battery being greater than or equal to a first temperature and an acceleration or a brake signal indicating hill climbing, rapid acceleration, or rapid deceleration.

The first thermal manager may be configured to block the liquid working fluid from a powertrain cooling device and to cool the battery by maximizing the use of a heat-exchanged liquid working fluid, and the second thermal manager may be configured to exchange heat between the gaseous working fluid cooled by a heating, ventilation, and air-conditioning (HVAC) and the liquid working fluid and to cool the battery by maximizing the use of the heat-exchanged gaseous working fluid cooled by the HVAC device, in response to a temperature of the battery being greater than or equal to a temperature.

The portions of the battery with likelihood of being short-circuited comprise a bus bar, a tap portion of each battery cell of the battery, and a battery cell located in the middle of each battery module.

In another general aspect, there is provided a battery thermal management method including exchanging heat between a liquid working fluid and a gaseous working fluid, regulating a battery temperature using the heat-exchanged liquid working fluid, and regulating the battery temperature using the heat-exchanged gaseous working fluid.

The exchanging of heat between the liquid working fluid and the gaseous working fluid may include blocking the liquid working fluid from a powertrain cooling device and exchanging heat between an external gaseous working fluid and the liquid working fluid, in response to a temperature of the battery being greater than or equal to a first temperature and less than a third temperature and an external temperature being less than a second temperature.

The exchanging of heat between the liquid working fluid and the gaseous working fluid may include blocking the liquid working fluid from a powertrain cooling device, and exchanging heat between the gaseous working fluid cooled by a heating, ventilation, and air-conditioning (HVAC) device and the liquid working fluid, in response to a temperature of the battery being greater than or equal to a first temperature and less than a third temperature and an external temperature being greater than or equal to a second temperature.

The exchanging of heat between the liquid working fluid and the gaseous working fluid may include allowing the liquid working fluid from a powertrain cooling device and exchanging heat between the gaseous working fluid heated by a heating, ventilation, and air-conditioning (HVAC) device and the liquid working fluid, in response to a temperature of the battery being less than a first temperature and an external temperature being less than a second temperature.

The exchanging of heat between the liquid working fluid and the gaseous working fluid may include allowing the liquid working fluid from a powertrain cooling device and exchanging heat between an external gaseous working fluid and the liquid working fluid, in response to a temperature of the battery being less than a first temperature and an external temperature is greater than or equal to a second temperature.

The battery thermal management method of may include determining whether hill climbing, rapid acceleration, or rapid deceleration occurs, in response to a temperature of the battery being greater than or equal to a first temperature, and wherein the exchanging of heat between the liquid working fluid and the gaseous working fluid may include blocking the liquid working fluid from a powertrain cooling device and exchanging heat between the gaseous working fluid cooled by a heating, ventilation, and air-conditioning (HVAC) device and the liquid working fluid, in response to determining the occurrence of any one or any combination of hill climbing, rapid acceleration, or rapid deceleration.

In response to a temperature of the battery being greater than or equal to a third temperature, the exchanging of heat between a liquid working fluid and a gaseous working fluid may include blocking the liquid working fluid from a powertrain cooling device and exchanging heat between the gaseous working fluid cooled by a heating, ventilation, and air-conditioning (HVAC) device and the liquid working fluid, the regulating of the battery temperature using the heat-exchanged liquid working fluid may include cooling the battery by maximizing the use of the heat-exchanged liquid working fluid, and the regulating of the battery temperature using the heat-exchanged gaseous working fluid may include cooling the battery by maximizing the use of a heat-exchanged gaseous working fluid cooled by the HVAC device.

Other features and aspects will be apparent from the following detailed description, the drawings, and the claims.

### BRIEF DESCRIPTION OF THE DRAWINGS

FIG. 1 is a diagram illustrating an example of a battery apparatus.

FIG. 2 is a diagram illustrating an example of the battery apparatus of FIG. 1.

FIG. 3A is a diagram illustrating an example of an operation of a battery thermal management device on the basis of battery and an external temperatures.

FIG. 3B is a diagram illustrating an example of an operation of a battery thermal management device on the basis of battery and an external temperatures.

FIG. 3C is a diagram illustrating an example of an operation of a battery thermal management device on the basis of battery and an external temperatures.

FIG. 3D is a diagram illustrating an example of an operation of a battery thermal management device on the basis of battery and an external temperatures.

FIG. 3E is a diagram illustrating an example of an operation of a battery thermal management device on the basis of temperature of a battery, external temperature, and temperature of a liquid working fluid.

FIG. 4 is a diagram illustrating an example of a battery thermal management device.

FIG. 5 is a diagram illustrating an example of a battery thermal management device.

FIGS. 6A to 6C are diagrams illustrating examples of a battery thermal management method.

FIG. 7 is a diagram illustrating an example of a battery thermal management method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or apparatuses described herein. However, various changes, modifications, and equivalents of the methods, apparatuses, and/or apparatuses described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or apparatuses described herein that will be apparent after an understanding of the disclosure of this application.

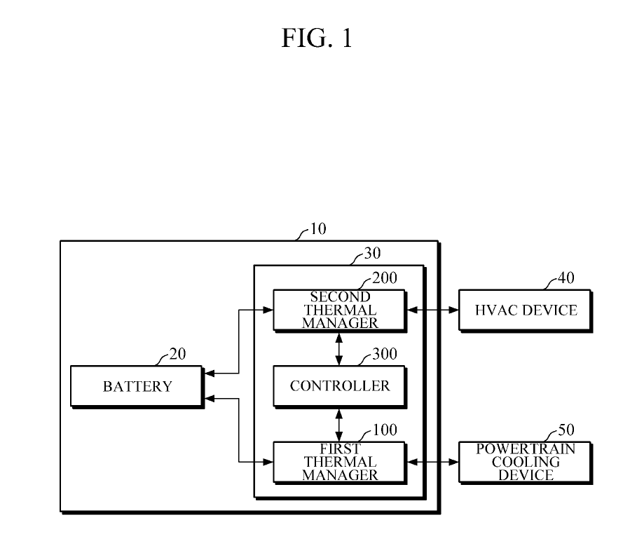

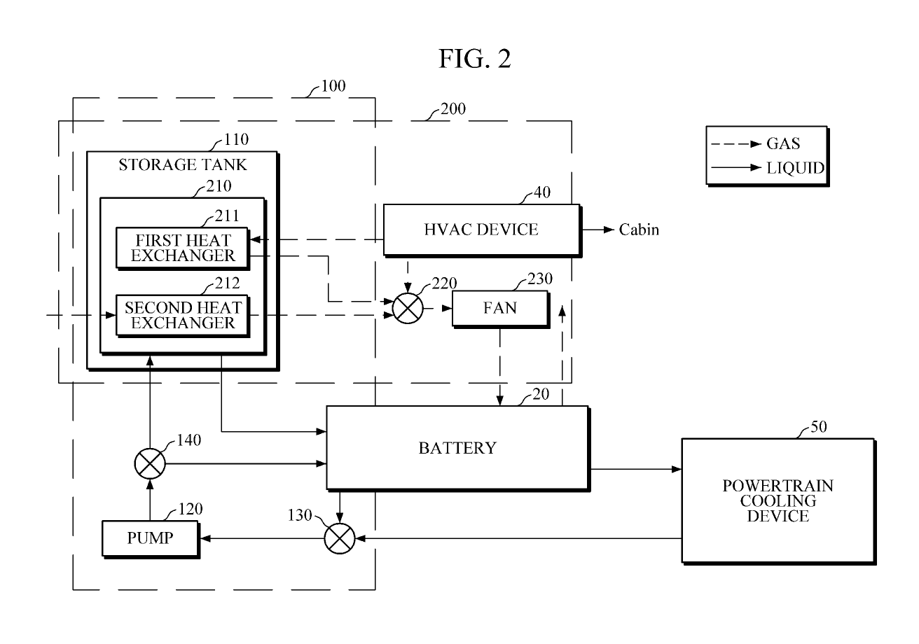

FIG. 1 is a diagram illustrating an example of a battery apparatus 10. FIG. 2 is a diagram illustrating an example of the battery apparatus 10. For convenience of explanation, a controller 300 is omitted in FIG. 2.

Referring to FIGS. 1 and 2, the battery apparatus 10 includes a battery 20 and a battery thermal management device 30.

The battery 20 supplies power to an apparatus in which the battery apparatus 10 is installed, such as, for example, an electric vehicle, an intelligent vehicle, a hybrid vehicle, an appliance, a smart appliance, a smart home environment, or a smart building environment. In an example, the battery 20 includes a plurality of battery modules connected in series and/or in parallel. Each of the battery modules may include a plurality of battery cells connected in series and/or in parallel. In an example, the plurality of battery modules or the plurality of battery cells may each be a secondary cell such as a nickel metal battery or a lithium ion battery, and may be connected to one another via a bus bar. The capacities of the plurality of battery modules or the plurality of battery cells may be the same or different from each other.

The battery thermal management device 30 may heat or cool the battery 20 using two types of working fluids. In an example, the battery thermal management device 30 may work together with a heating, ventilation, and air-conditioning (HVAC) device 40 and a powertrain cooling device 50. To this end, the battery thermal management device 30 may include a first thermal manager 100, a second thermal manager 200, and the controller 300.

In an example, the first thermal manager 100 heats or cools the battery 20 using a liquid working fluid according to a water cooling method. The first thermal manager 100 heats or cools the battery 20 according to the water cooling method by circulating the liquid working fluid using a liquid flow channel coupled to the battery 20. In an example, the first thermal manager 100 may be linked with the powertrain cooling device 50 by connecting a flow channel of the first thermal manager 100 to that of the powertrain cooling device 50. In an example, as shown in FIG. 2, the first thermal manager 100 includes a storage tank 110, a pump 120, and valves 130 and 140.

In an example, the storage tank 110 stores the liquid working fluid. In an example, the storage tank 110 has a heat insulation function to rapidly increase the temperature of the battery when an apparatus in which the battery apparatus 10 is installed is cold-started.

In an example, the pump 120 forces the liquid working fluid to be circulated.

In an example, the valve 130 allows a liquid working fluid from the powertrain cooling device 50 and from a flow channel near the battery 20 to flow into the pump 120 or blocks them from flowing into the pump 120.

In an example, the valve 140 allows a liquid working fluid to flow from the pump 120 to flow channels near the storage tank 110 and the battery 20 or block it from flowing to these flow channels.

In an example, the second thermal manager 200 heats or cools the battery 20 using a gaseous working fluid according to an air cooling method. The second thermal manager 200 heats or cools the battery 20 according to the air cooling method by supplying the gaseous working fluid to the battery 20. In an example, the second thermal manager 200 may work together with the first thermal manager 100 and the HVAC device 40. For example, the second thermal manager 200 may work together with the first thermal manager 100 by exchanging heat between a liquid working fluid used in the first thermal manager 100 and the gaseous working fluid used in the second thermal manager 200. The second thermal manager 200 may work together with the HVAC device 40 using the gaseous working fluid heated using the HVAC device 40 (hereinafter referred to as the “HVAC-heated gaseous working fluid”) or the gaseous working fluid cooled using the HVAC device 40 (hereinafter referred to as the “HVAC-cooled gaseous working fluid”). In an example, the second thermal manager 200 may include a heat exchanger 210, a valve 220, and a fan 230.

The heat exchanger 210 may exchange heat between at least one among the HVAC-heated gaseous working fluid, the HVAC-cooled gaseous working fluid, a gaseous working fluid flowing from the outside (hereinafter referred to as the ‘external gaseous working fluid’) and the liquid working fluid used in the first thermal manager 100. The heat exchanger 210 may provide the valve 220 with the heat-exchanged gaseous working fluid. In an example, the heat exchanger 210 includes a first heat exchanger 211 and a second heat exchanger 212. The first heat exchanger 211 exchanges heat between either the HVAC-heated gaseous working fluid or the HVAC-cooled gaseous working fluid and the liquid working fluid used in the first thermal manager 100. The second heat exchanger 212 exchanges heat between an external gaseous working fluid and the liquid working fluid used in the first thermal manager 100.

In one embodiment, the first heat exchanger 211 and the second heat exchanger 212 may be radiators, which are generally used as heat exchangers. Any device that exchanges heat between fluids may be used as the first heat exchanger 211 and the second heat exchanger 212 may be used without departing from the spirit and scope of the illustrative examples described.

In one embodiment, the heat exchanger 210 is provided in the storage tank 110 of the first thermal manager 100. The first thermal manager 100 and the second thermal manager 200 may work together through the heat exchanger 210.

In an example, the valve 220 allows the gaseous working fluid flowing from the heat exchanger 210 and an external gaseous working fluid that does not pass through the heat exchanger 210 to flow to the fan 230 or block them from flowing to the fan 230.

The rotating blades of the fan 230 supply the gaseous working fluid flowing from the valve 220 to the battery 20.

In one embodiment, the flow channel of the first thermal manager 100 and the flow channel of the second thermal manager 200 may be configured according to characteristics of the battery 20. For example, the flow channel of the first thermal manager 100 is provided on portions of the battery 20 except portions that are likely to be short-circuited, such as, for example, a bus bar, a tap portion of each battery cell, and a battery cell located in the middle of each battery module. In an example, the flow channel of the second thermal manager 200 is provided on all portions of the battery 20, including the bus bar, the tap portion of each battery cell, the battery cell located in the middle of each battery module.

In an example, the controller 300 controls overall operations of the battery thermal management device 30. Furthermore, the controller 300 may operate the HVAC device 40 to cool or heat the gaseous working fluid.

In one embodiment, the controller 300 determine whether the battery is to be cooled or heated, whether the first thermal manager 100 and the powertrain cooling device 50 are to work together, whether the second thermal manager 200 and the HVAC device 40 are to work together, whether the first thermal manager 100 and the second thermal manager 200 are to work together, the amount of the liquid working fluid flowing from the powertrain cooling device 50 to the battery thermal management device 30. In an example, the controller 300 determines whether hill climbing/rapid acceleration/rapid deceleration occur on the basis of factors, such as, for example, the temperature of the battery 20, the external temperature, the temperature of the liquid working fluid, the rotation speed of a powertrain, an acceleration signal, a brake signal. The controller 300 controls operations of the valves 130, 140, 220, the pump 120, the fan 230, the first heat exchanger 211, and the second heat exchanger 212 based on the determination. In an example, the controller 300 controls the speed of the fan 230 and a flow rate of the liquid working fluid used to cool the battery 20 on the basis of the temperature of the battery 20.

For example, the controller 300 determines that the battery 20 needs to be cooled and not work with the powertrain cooling device 50 when the temperature of the battery 20 is greater than or equal to a third threshold temperature, determine that the battery 20 needs to be heated and work with the powertrain cooling device 50 when the temperature of the battery 20 is less than the third threshold temperature, and controls the first thermal manager 100 and the second thermal manager 200 on the basis of the determination. In this case, the third threshold temperature may be 35° C. but is not limited thereto and may be set to various values according to the performance and use of the apparatus.

In an example, the controller 300 determines that the battery 20 needs to work with the HVAC device 40 when it is determined that the battery 20 needs to be cooled and not work with the powertrain cooling device 50 (when the temperature of the battery 20 is greater than or equal to the third threshold temperature) and that external temperature is greater than or equal to a second threshold temperature. In another example, the controller 300 determines that the battery 20 need not work with the HVAC device 40 when it is determined that the battery 20 needs to be heated and work with the powertrain cooling device 50 (when the temperature of the battery 20 is less than the third threshold temperature) and that external temperature is less than the second threshold temperature, and controls the first thermal manager 100 and the second thermal manager 200 according to the determination. In this case, the second threshold temperature may be 30° C. but is not limited thereto and may be set to various values according to the performance and use of the apparatus.

In an example, the controller 300 determines that the battery 20 need not work with the HVAC device 40 when it is determined that the battery 20 needs to be heated and work with the powertrain cooling device 50 (when the temperature of the battery 20 is less than the third threshold temperature) and that the external temperature is greater than or equal to a first threshold temperature. In another example, the controller 300 determines that the battery 20 needs to work with the HVAC device 40 when it is determined that the battery 20 needs to be cooled and not work with the powertrain cooling device 50 (when the temperature of the battery 20 is greater than or equal to the third threshold temperature) and that the external temperature is less the first threshold temperature, and controls the first thermal manager 100 and the second thermal manager 200 according to the determination. In this case, the first threshold temperature may be 25° C. but is not limited thereto and may be set to various values according to the performance and use of the apparatus.

In an example, the controller 300 determines that the first thermal manager 100 and the second thermal manager 200 do not need to work together when it is determined that the battery 20 needs to be cooled and not work with the powertrain cooling device 50 and the HVAC device 40 (when the temperature of the battery 20 is greater than or equal to the third threshold temperature and the external temperature is greater than or equal to the first threshold temperature) and that temperature of the liquid working fluid is less than the third threshold temperature, and controls the first thermal manager 100 and the second thermal manager 200 according to the determination.

In an example, the controller 300 determines that the battery 20 needs to be cooled and not work with the powertrain cooling device 50 and needs to work with the HVAC device 40 when the temperature of the battery 20 is greater than or equal to a fourth threshold temperature, and controls the first thermal manager 100 and the second thermal manager 200 to cool the battery 20 as soon as possible by maximizing the use of the HVAC device 40, the liquid working fluid, and the gaseous working fluid. For example, when the temperature of the battery 20 is greater than or equal to the fourth threshold temperature, the controller 300 controls the first thermal manager 100 and the second thermal manager 200 to operate the HVAC device 40 at a maximum level and maximize flow rates of the liquid working fluid and the gaseous working fluid to be used to cool the battery 20 so that the battery 20 is cooled as soon as possible. In this case, the fourth threshold temperature may be 45° C. but is not limited thereto and may be set to various values according to the performance and use of the apparatus.

In an example, the controller 300 analyzes an acceleration signal or a brake signal, and determines whether hill climbing, rapid acceleration, or rapid deceleration occurs when a ratio between maximum acceleration/maximum deceleration and current acceleration/current deceleration is 0.7 or more. When hill climbing, rapid acceleration, or rapid deceleration occurs, the temperature of the battery 20 is likely to increase sharply and instantaneously. Thus, the controller 300 determines that the battery 20 needs to be cooled and not work with the powertrain cooling device 50 and needs to work with the HVAC device 40 when it is determined that the temperature of the battery 20 is greater than or equal to the third threshold temperature and hill climbing, rapid acceleration, or rapid deceleration occurs. The controller 300 controls the first thermal manager 100 and the second thermal manager 200 according to a result of the determination. In this case, the speed of the fan 230 and the flow rate of the liquid working fluid used to cool the battery 20 may be controlled based on the ratio between maximum acceleration/maximum deceleration and current acceleration/current deceleration.

When it is determined that the battery 20 needs to be cooled or heated in association with the HVAC device 40, the controller 300 may operate the HVAC device 40 to cool or heat the gaseous working fluid to be used to cool or heat the battery 20. In an example, the controller 300 controls a strength or intensity of an operation of the HVAC device 40 according to the temperature of the battery 20. For example, the controller 300 maximizes the strength or intensity of the operation of the HVAC device 40 when the temperature of the battery 20 is greater than or equal to the fourth threshold temperature.

In an example, the controller 30 controls the valve 130 to allow the liquid working fluid to flow from the powertrain cooling device 50 when it is determined that the battery 20 needs to be heated in association with the powertrain cooling device 50, and controls the valve 130 to block the liquid working fluid from flowing from the powertrain cooling device 50 when it is determined that the battery 20 need not be heated in association with the powertrain cooling device 50. In this case, the controller 300 may control an inflow rate of the liquid working fluid from the powertrain cooling device 50 according to the temperature of the battery 20.

The HVAC device 40 may act as a heat pump to heat the gaseous working fluid or act as an air conditioner to cool the gaseous working fluid. When the external temperature is equal to or less than a predetermined temperature (e.g., −15° C.), the HVAC device 40 may heat the gaseous working fluid using a positive temperature coefficient (PTC) heater as an additional heat source.

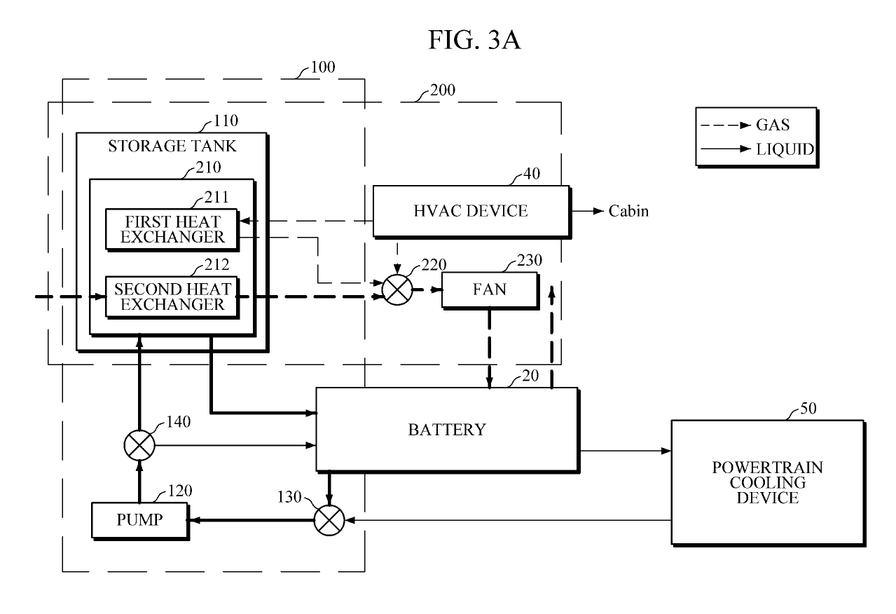

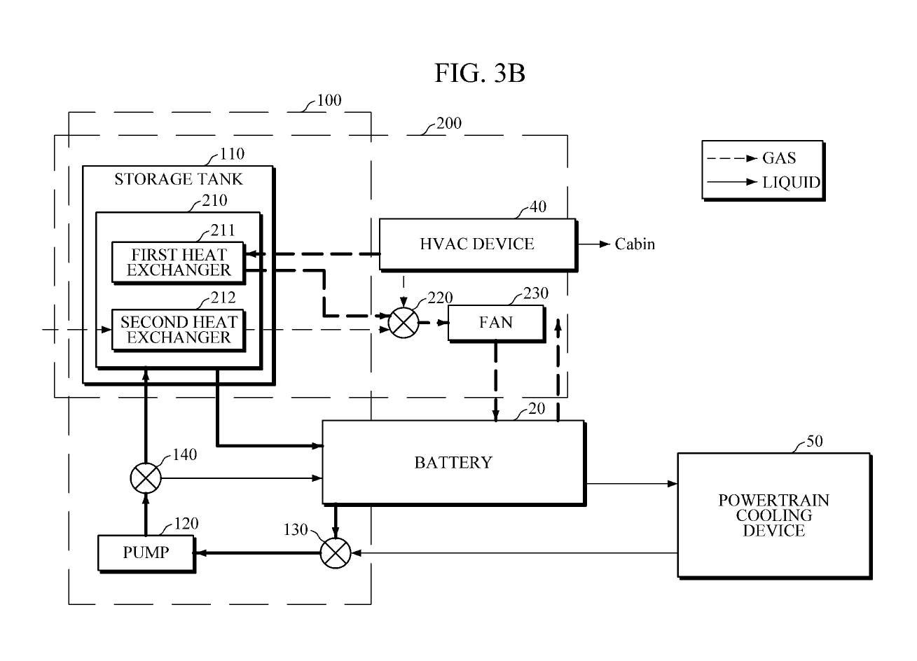

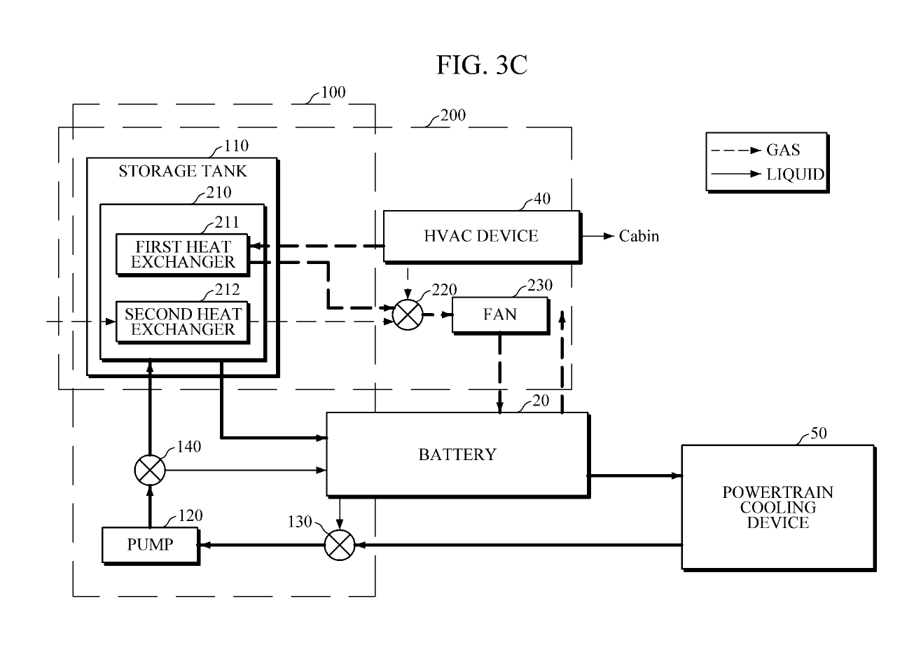

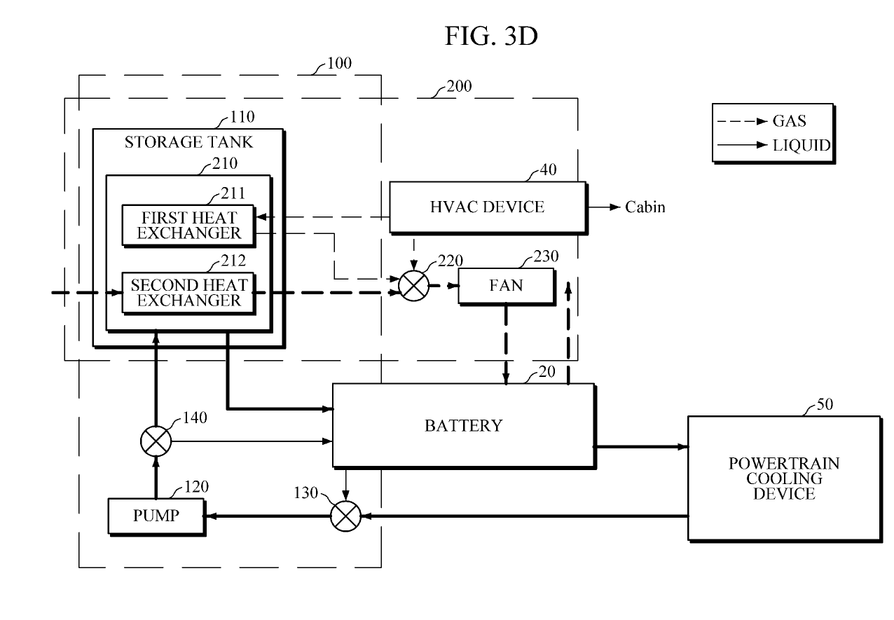

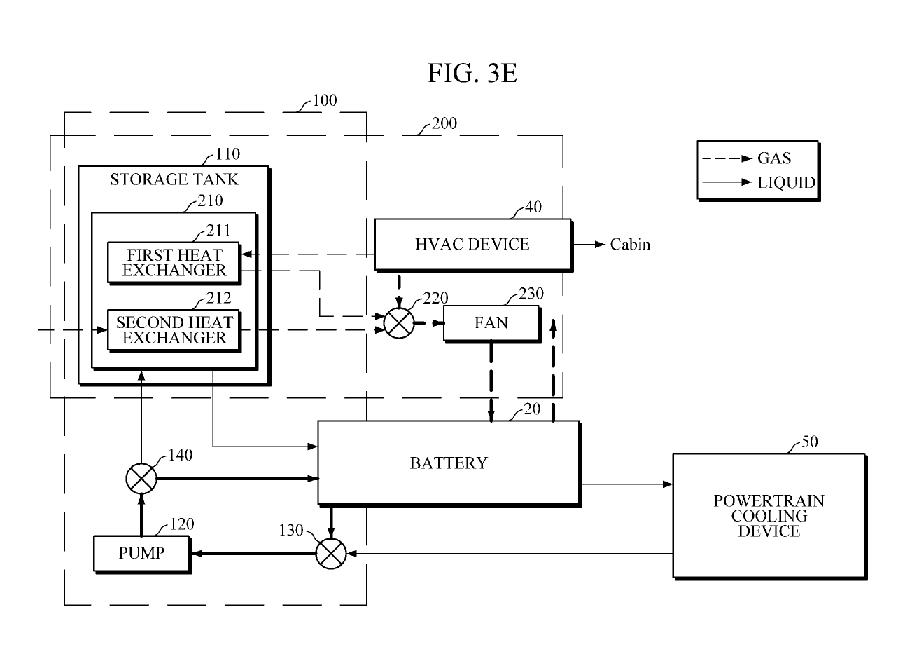

Overall operations of the battery thermal management device 30 will be described in detail with reference to FIGS. 3A to 3E below.

FIG. 3A is a diagram illustrating an example of the operation of the battery thermal management device 30 of FIG. 2 on the basis of a temperature of the battery 20 and an external temperature. In the embodiment of FIG. 3A, the temperature of the battery 20 is greater than a third threshold temperature and the external temperature is less than a second threshold temperature. In this case, the controller 300 determines that the battery 20 needs to be cooled, and not work with the powertrain cooling device 50 and the HVAC device 40. The first thermal manager 100 controls the valve 130 to block a liquid working fluid from flowing from the powertrain cooling device 50 under control of the controller 300.

Referring to FIG. 3A, the first thermal manager 100 cools the battery 20 by circulating the liquid working fluid through a flow path comprising the battery 20, the valve 130, the pump 120, the valve 140, the storage tank 110, and back to the battery 20. The liquid working fluid is blocked from flowing from the powertrain cooling device 50. In an example, heat is exchanged between the liquid working fluid and an external gaseous working fluid in the storage tank 110 via the second heat exchanger 212, and the first thermal manager 100 cools the battery 20 using the heat-exchanged liquid working fluid.

The second thermal manager 200 exchanges heat between the external gaseous working fluid and the liquid working fluid in the storage tank 110 via the second heat exchanger 212, and causes the heat-exchanged external gaseous working fluid to flow to the battery 20 via the fan 230, thereby cooling the battery 20.

FIG. 3B is a diagram illustrating an example of an operation of the battery thermal management device 30 of FIG. 2 on the basis of a temperature of the battery 20 and an external temperature. In the embodiment of FIG. 3B, the temperature of the battery 20 is greater than a third threshold temperature and the external temperature is greater than a second threshold temperature. In this case, the controller 300 determines that the battery 20 needs to be cooled, not work with the powertrain cooling device 50, and needs to work with the HVAC device 40. The HVAC device 40 cools a gaseous working fluid and the first thermal manager 100 controls the valve 130 to block a liquid working fluid from flowing from the powertrain cooling device 50, according to control of the controller 300.

Referring to FIG. 3B, the first thermal manager 100 cools the battery 20 by circulating the liquid working fluid via a flow path comprising the battery 20, the valve 130, the pump 120, the valve 140, the storage tank 110, and back to the battery 20. The liquid working fluid is blocked from flowing from the powertrain cooling device 50. In this case, heat is exchanged between the liquid working fluid and an HVAC-cooled gaseous working fluid in the storage tank 110 via the first heat exchanger 211. The first thermal manager 100 cools the battery 20 using the heat-exchanged liquid working fluid.

The second thermal manager 200 exchanges heat between the HVAC-cooled gaseous working fluid and the liquid working fluid in the storage tank 110 via the first heat exchanger 211, and causes the heat-exchanged HVAC-cooled gaseous working fluid to flow to the battery 20 via the fan 230, thereby cooling the battery 20.

FIG. 3C is a diagram illustrating an example of an operation of the battery thermal management device 30 of FIG. 2 on the basis of a temperature of the battery 20 and an external temperature. In the embodiment of FIG. 3C, the temperature of the battery 20 is less than a third threshold temperature and the external temperature is less than a first threshold temperature. In this case, a controller 300 determines that the battery 20 needs to be heated and works with the powertrain cooling device 50 and the HVAC device 40. In this case, the HVAC device 40 heats a gaseous working fluid and a first thermal manager 100 controls the valve 130 to allow the liquid working fluid to flow from the powertrain cooling device 50, under control of the controller 300.

Referring to FIG. 3C, the first thermal manager 100 heats the battery 20 by circulating the liquid working fluid via a flow path comprising the battery 20, the powertrain cooling device 50, the valve 130, the pump 120, the valve 140, the storage tank 110, and back to the battery 20. In this case, the liquid working fluid flowing from the powertrain cooling device 50 to the valve 130 passes through the pump 120 and the valve 140, and heat is exchanged between the liquid working fluid and an HVAC-heated gaseous working fluid in the storage tank 110 via the first heat exchanger 211. The first thermal manager 100 heats the battery 20 using the heat-exchanged liquid working fluid. In an example, the liquid working fluid flowing from the powertrain cooling device 50 to the valve 130 may be a liquid working fluid heated when it is used to cool the powertrain. The amount of the liquid working fluid is adjusted on the basis of factors such as, for example, the temperature of the battery 20, the external temperature, the rotation speed of the powertrain, under control of the controller 300.

The second thermal manager 200 exchanges heat between a HVAC-heated gaseous working fluid and the liquid working fluid in the storage tank 110 via the first heat exchanger 211, and causes the heat-exchanged HVAC-heated gaseous working fluid to flow to the battery 20 via the fan 230, thereby heating the battery 20.

FIG. 3D is a diagram illustrating an example of operation of the battery thermal management device 30 of FIG. 2 on the basis of a temperature of the battery 20 and an external temperature. In the embodiment of FIG. 3D, the temperature of the battery 20 is less than a third threshold temperature and the external temperature is greater than a first threshold temperature. In this case, the controller 300 determines that the battery 20 needs to be heated, work with the powertrain cooling device 50, and does not work with the HVAC device 40. In this case, the first thermal manager 100 may control the valve 130 to allow the liquid working fluid to flow from the powertrain cooling device 50, under control of the controller 300.

Referring to FIG. 3D, the first thermal manager 100 heats the battery 20 by circulating the liquid working fluid via a flow path comprising the battery 20, the powertrain cooling device 50, the valve 130, the pump 120, the valve 140, the storage tank 110, and back to the battery 20. In this case, the liquid working fluid flowing to the valve 130 from the powertrain cooling device 50 passes through the pump 120 and the valve 140, and heat is exchanged between the liquid working fluid and an external gaseous working fluid in the storage tank 110 via the second heat exchanger 212. The first thermal manager 100 heats the battery 20 using the heat-exchanged liquid working fluid. Here, the liquid working fluid flowing to the valve 130 from the powertrain cooling device 50 may be a liquid working fluid heated by being used to cool a powertrain. The amount of the liquid working fluid is controlled on the basis of factors such as, for example, the temperature of the battery 20, the external temperature, and the rotation speed of the powertrain, under control of the controller 300.

The second thermal manager 200 exchanges heat between an external gaseous working fluid and the liquid working fluid in the storage tank 110 via the second heat exchanger 212, and causes the heat-exchanged external gaseous working fluid to flow to the battery 20 via the fan 230, thereby heating the battery 20.

FIG. 3E is a diagram illustrating an example of operation of the battery thermal management device 30 of FIG. 2 on the basis of a temperature of the battery 20, an external temperature, and a temperature of a liquid working fluid. In the embodiment of FIG. 3E, the temperature of the battery 20 is greater than a third threshold temperature, the external temperature is less than a second threshold temperature, and the temperature of the liquid working fluid is less than the third threshold temperature. In this case, the controller 300 determines that the battery 20 needs to be cooled and not work with the powertrain cooling device 50 and the HVAC device 40, and the first thermal manager 100 and the second thermal manager 200 do not need to work together. In this case, the first thermal manager 100 controls the valve 130 to block the liquid working fluid from flowing from the powertrain cooling device 50, under control of the controller 300.

Referring to FIG. 3E, the first thermal manager 100 cools the battery 20 by circulating the liquid working fluid via a flow path comprising the battery 20, the valve 130, the pump 120, the valve 140, and back to the battery 20. The second thermal manager 200 causes an external gaseous working fluid to flow to the battery 20 to cool the battery 20.

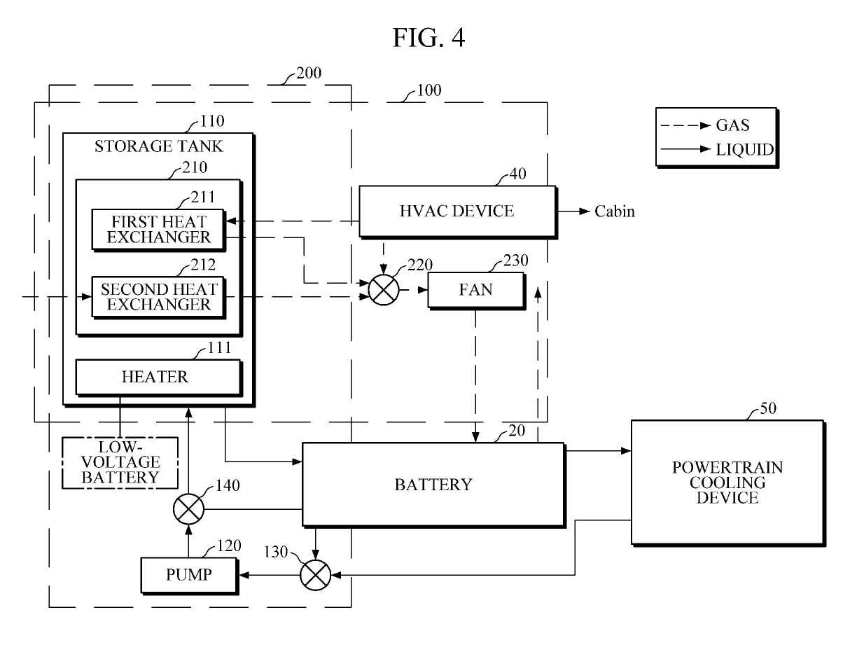

FIG. 4 is a diagram illustrating an example of a battery thermal management device 30.

Referring to FIG. 4, the battery thermal management device 30 includes a heater 111 in a storage tank 110.

In an example, the heater 111 rapidly heats a liquid working fluid when a battery 20 needs to be heated immediately, such as, when an apparatus in which a battery apparatus 10 of FIG. 1 is installed is started. In an example, the heater 111 is a PTC heater but is not limited thereto.

In one embodiment, when the battery 20 is charged, the battery thermal management device 30 maintains temperature of the liquid working fluid at a predetermined level (e.g., 45° C.) using the heater 111, and heats the battery 20 by operating a pump 120 when the temperature of the battery 20 is low.

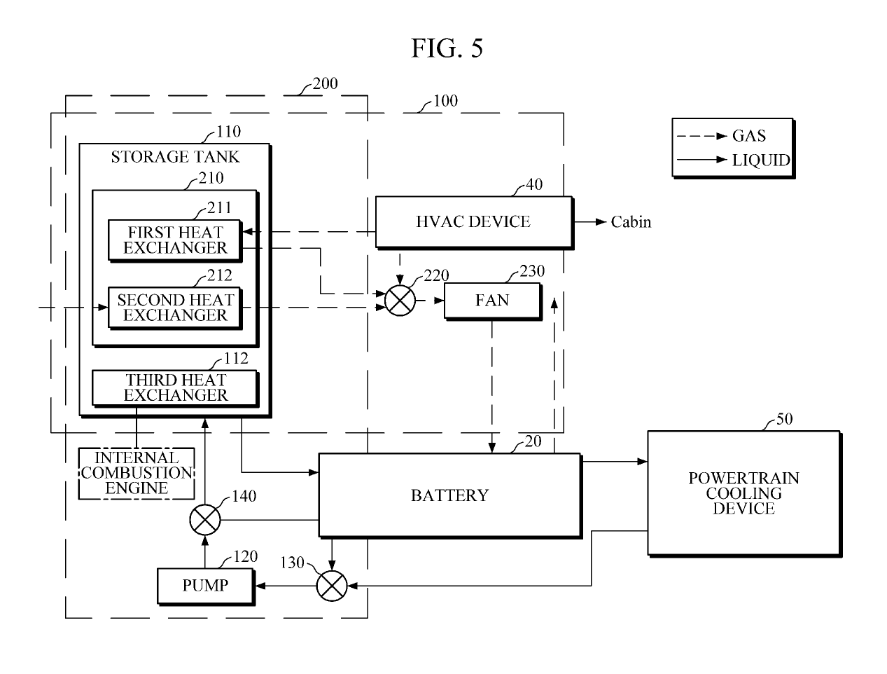

FIG. 5 is a diagram illustrating an example of a battery thermal management device 30.

Referring to FIG. 5, the battery thermal management device 30 includes a third heat exchanger 112 in storage tank 110.

The third heat exchanger 112 may exchanges heat between a high-temperature exhaust gas emitted from an internal combustion engine and either a gaseous working fluid or a liquid working fluid.

When the battery 20 needs to be heated, the battery thermal management device 30 uses the high-temperature exhaust gas emitted from the internal combustion engine without using additionally electric energy, thereby rapidly heating the gaseous working fluid or the liquid working fluid.

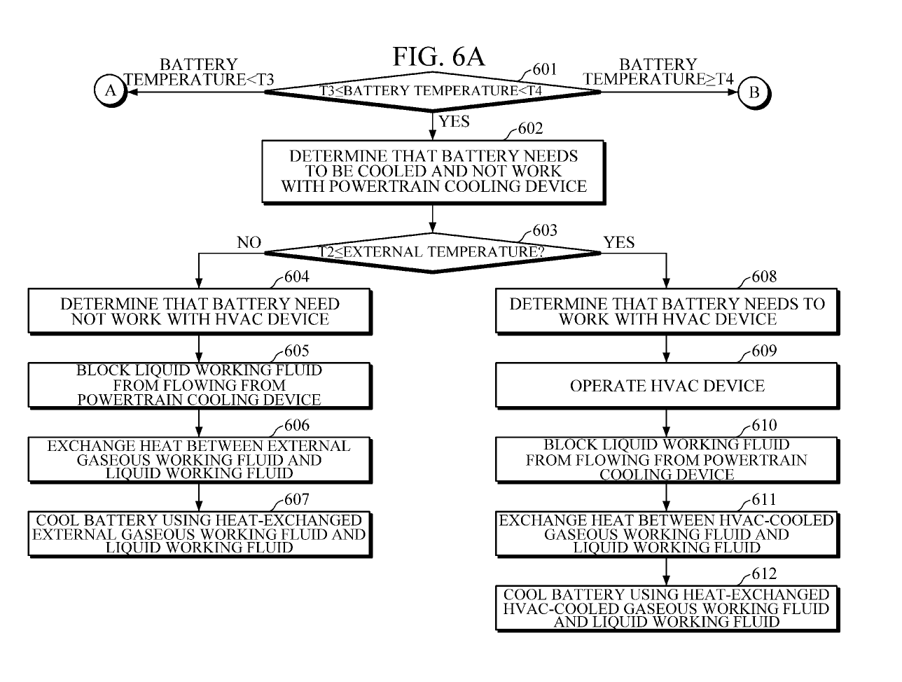

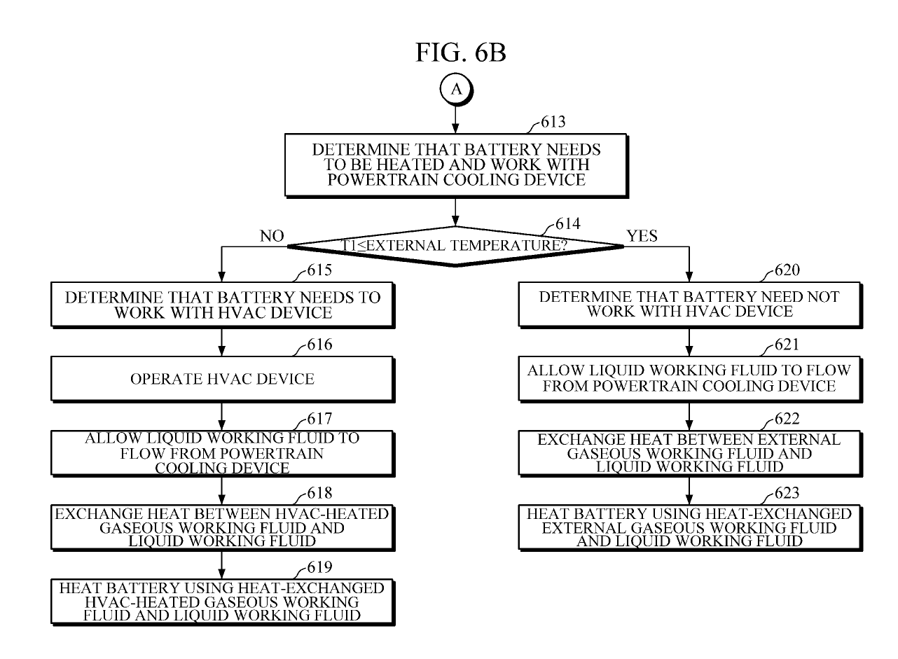

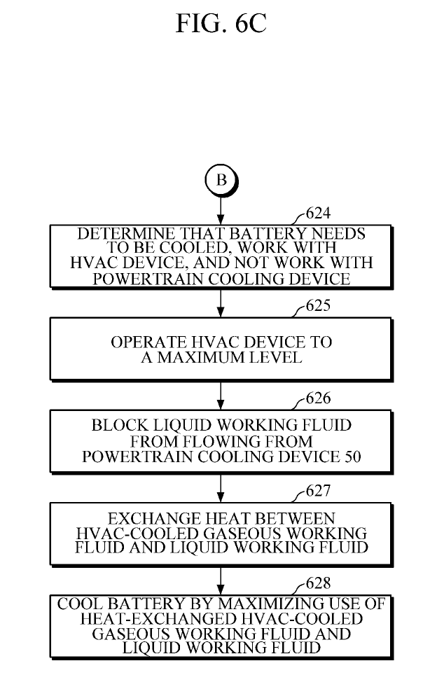

FIGS. 6A to 6C are diagrams illustrating examples of a battery thermal management method. The operations in FIGS. 6A to 6C may be performed in the sequence and manner as shown, although the order of some operations may be changed or some of the operations omitted without departing from the spirit and scope of the illustrative examples described. Many of the operations shown in FIGS. 6A to 6C may be performed in parallel or concurrently. In addition to the description of FIGS. 6A to 6C below, the above descriptions of FIGS. 1-5, are also applicable to FIGS. 6A to 6C, and are incorporated herein by reference. Thus, the above description may not be repeated here

Referring to FIGS. 1, 2, and 6A to 6C, in 601, the battery thermal management device 30 determines whether a temperature of a battery is greater than or equal to a third threshold temperature T3 and less than a fourth threshold temperature T4. In an example, the third threshold temperature T3 is 35° C. and the fourth threshold temperature T4 is 45° C. but are not limited thereto and may be variously set according to the performance and use of the apparatus.

In 602, when the temperature of the battery is greater than or equal to the third threshold temperature T3 and less than the fourth threshold temperature T4, the battery thermal management device 30 determines that the battery needs to be cooled and not work with a powertrain cooling device. In 603, battery thermal management device 30 determines whether the external temperature is greater than or equal to a second threshold temperature T2. In an example, the second threshold temperature T2 may be 30° C. but is not limited thereto and may be variously set according to the performance and use of the apparatus.

When it is determined that the external temperature is less than the second threshold temperature T2, in 604, the battery thermal management device 30 determines that the battery need not work with the HVAC device. In 605, the battery thermal management device 30 blocks a liquid working fluid from flowing from the powertrain cooling device. In 606, the battery thermal management device 30 exchanges heat between an external gaseous working fluid and the liquid working fluid. In 607, the battery thermal management device 30 cools the battery according to an air cooling method using the heat-exchanged external gaseous working fluid via the second thermal manager 200, and cools the battery according to a water cooling method using the heat-exchanged liquid working fluid via the first thermal manager 100. In an example, the cooling of the battery according to the air cooling method is performed on portions of the battery that are highly to be short circuited, such as, a bus bar, a tap portion of each battery cell, and a battery cell located in the middle of each battery module, and the cooling of the battery according to the water cooling method is performed on portions of the battery except the portions that are likely to be short circuited.

In 603, when it is determined that the external temperature is greater than or equal to the second threshold temperature T2, the battery thermal management device 30 determines that the battery needs to work with the HVAC device, in 608. In 609, the battery thermal management device 30 operates the HVAC device 40 as an air conditioner. In 610, the battery thermal management device 30 blocks the liquid working fluid from flowing from the powertrain cooling device. In 611, the battery thermal management device 30 exchanges heat between an HVAC-cooled gaseous working fluid and the liquid working fluid. In 612, the battery thermal management device 30 cools the battery according to the air cooling method using the heat-exchanged HVAC-cooled gaseous working fluid via the second thermal manager 200, and cools the battery according to the water cooling method using the heat-exchanged liquid working fluid via the first thermal manager 100. In an example, the cooling of the battery according to the air cooling method is performed on the portions of the battery that are likely to be short circuited, such as, the bus bar, the tap portion of each battery cell, and the battery cell located in the middle of each battery module, and the cooling of the battery according to the water cooling method is performed on the portions of the battery except the portions that are likely to be short circuited.

When it is determined in 601 that the temperature of the battery is less than the third threshold temperature T3, in 613, the battery thermal management device 30 determines that the battery needs to be heated and work with the powertrain cooling device. In 614, the battery thermal management device 30 determines whether the external temperature is greater than or equal to the first threshold temperature T1. In an example, the first threshold temperature T1 may be 25° C. but is not limited thereto and may be variously set according to the performance and use of the apparatus.

In 614, when it is determined that the external temperature is less than the first threshold temperature T1, the battery thermal management device 30 determines that the battery needs to work with the HVAC device in 615. In 616, the battery thermal management device 30 operates the HVAC device as a heat pump. In 617, the battery thermal management device 30 allows the liquid working fluid to flow from the powertrain cooling device 50 and in 618, exchanges heat between an HVAC-heated gaseous working fluid and the liquid working fluid. In 619, the battery thermal management device 30 heats the battery according to the air cooling method using the heat-exchanged HVAC-heated gaseous working fluid via second thermal manager 200, and heats the battery according to the water cooling method using the heat-exchanged liquid working fluid via the first thermal manager 100. In an example, the heating of the battery according to the air cooling method is performed on the portions of the battery that are likely to be short circuited, such as, the bus bar, the tap portion of each battery cell, and the battery cell located in the middle of each battery module, and the heating of the battery according to the water cooling method is performed on the portions of the battery except the portions that are likely to be short circuited.

In 614, when it is determined that the external temperature is greater than or equal to the first threshold temperature T1, in 620, the battery thermal management device 30 determines that the battery need not work with the HVAC device. In 621, the battery thermal management device 30 allows the liquid working fluid to flow from the powertrain cooling device, and in 622, the battery thermal management device 30 exchanges heat between an external gaseous working fluid and the liquid working fluid. In 623, the battery thermal management device 30 heats the battery according to the air cooling method using the heat-exchanged external gaseous working fluid via the second thermal manager 200, and heats the battery according to the water cooling method using the heat-exchanged liquid working fluid via the first thermal manager 100. In an example, the heating of the battery according to the air cooling method is performed on the portions of the battery that are likely to be short circuited, such as, the bus bar, the tap portion of each battery cell, and the battery cell located in the middle of each battery module, and the heating of the battery according to the water cooling method is performed on the portions of the battery except the portions that are likely to be short circuited.

When it is determined in operation 601 that the temperature of the battery is greater than or equal to the fourth threshold temperature T4, in 624, the battery thermal management device 30 determines that the battery needs to be cooled, work with the HVAC device, and need not work with the powertrain cooling device. In 625, the battery thermal management device 30 operates the HVAC device 40 as an air conditioner at a maximum level. In 626, the battery thermal management device 30 blocks the liquid working fluid from flowing from the powertrain cooling device. In 627, the battery thermal management device 30 exchanges heat between the HVAC-cooled gaseous working fluid and the liquid working fluid. In 628, the battery thermal management device 30 cools the battery according to the air cooling method by maximizing the use of the heat-exchanged HVAC-cooled gaseous working fluid via the second thermal manager 200, and cools the battery according to the water cooling method by maximizing the use of the heat-exchanged liquid working fluid via the first thermal manager 100. For example, the battery thermal management device 30 may cool the battery by maximizing the flow rates of the heat-exchanged HVAC-cooled gaseous working fluid and the heat-exchanged liquid working fluid. In an example, the cooling of the battery 20 according to the air cooling method is performed on the portions of the battery that are likely to be short circuited, such as, the bus bar, the tap portion of each battery cell, and the battery cell located in the middle of each battery module, and the cooling of the battery according to the water cooling method is performed on the portions of the battery except the portions that are likely to be short circuited.

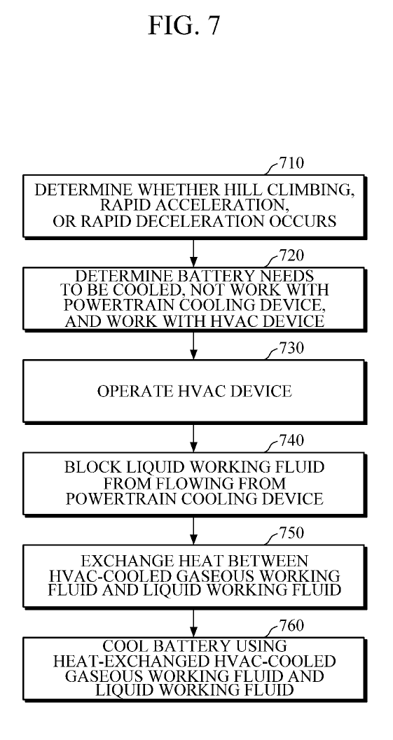

FIG. 7 is a diagram illustrating an example of a battery thermal management method. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. In addition to the description of FIG. 7 below, the above descriptions of FIGS. 1-6C, are also applicable to FIG. 7, and are incorporated herein by reference. Thus, the above description may not be repeated here.

Referring to FIGS. 1, 2, and 7, in 710, the battery thermal management device 30 determines whether hill climbing, rapid acceleration, or rapid deceleration occurs when a temperature of a battery is greater than a third threshold temperature. For example, the battery thermal management device 30 analyzes an acceleration signal or a brake signal, and determine that hill climbing, rapid acceleration, or rapid deceleration occurs when a ratio between maximum acceleration/maximum deceleration and current acceleration/current deceleration is 0.7 or more.

When it is determined that hill climbing, rapid acceleration, or rapid deceleration occurs, in 720, the battery thermal management device 30 determines that the battery 20 needs to be cooled, not work with the powertrain cooling device 50, and needs to work with the HVAC device 40. In 730, the battery thermal management device 30 operates the HVAC device 40 as an air conditioner. In 740, the battery thermal management device 30 blocks a liquid working fluid flowing from the powertrain cooling device 50. In 750, the battery thermal management device 30 exchanges heat between an HVAC-cooled gaseous working fluid and the liquid working fluid. In 760, the battery thermal management device 30 cools the battery 20 according to the air cooling method using the heat-exchanged HVAC-cooled gaseous working fluid via the second thermal manager 200, and cools the battery 20 according to the water cooling method using the heat-exchanged liquid working fluid via the first thermal manager. In an example, the cooling of the battery 20 according to the air cooling method is performed on portions of the battery 20 that are likely to be short circuited, such as, a bus bar, a tap portion of each battery cell, and a battery cell located in the middle of each battery module, and the cooling of the battery 20 according to the water cooling method is performed on portions of the battery 20 except the portions that are highly likely to be short circuited.

The battery thermal management device 30, first thermal manager 100, second thermal manager 200, and the controller 300 described in FIG. 1 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 6A-7 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery thermal management device comprising:
a first thermal manager configured to regulate a battery temperature using a liquid working fluid; and
a second thermal manager configured to regulate the battery temperature using a gaseous working fluid,
wherein the second thermal manager works with the first thermal manager by exchanging heat between the liquid working fluid and the gaseous working fluid.

2. The battery thermal management device of claim 1, wherein a flow channel for the liquid working fluid connects the first thermal manager to the powertrain cooling device.

3. The battery thermal management device of claim 1, wherein the second thermal manager is further configured to use a gaseous working fluid heated or cooled by a heating, ventilation, and air-conditioning (HVAC) device.

4. The battery thermal management device of claim 1, wherein the first thermal manager comprises a storage tank configured to store the liquid working fluid.

5. The battery thermal management device of claim 4, wherein the second thermal manager comprises a heat exchanger provided in the storage tank, the heat exchanger being configured to exchange heat between the liquid working fluid and the gaseous working fluid.

6. The battery thermal management device of claim 4, wherein the storage tank is configured to be a heat insulator.

7. The battery thermal management device of claim 4, wherein the storage tank comprises a heater configured to heat the liquid working fluid.

8. The battery thermal management device of claim 4, wherein the storage tank comprises a third heat exchanger configured to exchange heat between an exhaust gas of an engine and any one or any combination of the gaseous working fluid and the liquid working fluid.

9. The battery thermal management device of claim 1, wherein a flow channel for the liquid working fluid is excluded from portions of the battery with likelihood of being short-circuited, and a flow channel of the gaseous working fluid is provided all portions of the battery.

10. The battery thermal management device of claim 1, wherein, the first thermal manager is further configured to block the liquid working fluid flowing from a powertrain cooling device and to cool the battery using a heat-exchanged liquid working fluid, and the second thermal manager is further configured to exchange heat between an external gaseous working fluid and the liquid working fluid and to cool the battery using the heat-exchanged external gaseous working fluid, in response to a temperature of the battery being greater than or equal to a first temperature and less than a third temperature and an external temperature being less than a second temperature.

11. The battery thermal management device of claim 1, wherein the first thermal manager is further configured to block the liquid working fluid flowing from a powertrain cooling device and to cool the battery using a heat-exchanged liquid working fluid, and the second thermal manager is further configured to exchange heat between the gaseous working fluid cooled by a heating, ventilation, and air-conditioning (HVAC) device and the liquid working fluid and to cool the battery using the heat-exchanged gaseous working fluid, in response to a temperature of the battery being greater than or equal to a first temperature and less than a third temperature and an external temperature being greater than or equal to a second temperature.

12. The battery thermal management device of claim 1, wherein the first thermal manager is further configured to allow the liquid working fluid from a powertrain cooling device and to heat the battery using a heat-exchanged liquid working fluid, and the second thermal manager is further configured to exchange heat between the liquid working fluid from the powertrain cooling device and the gaseous working fluid heated by a heating, ventilation, and air-conditioning (HVAC) device and to heat the battery using the heat-exchanged gaseous working fluid heated by the HVAC device, when a temperature of the battery is less than a first temperature and an external temperature being less than a second temperature.

13. The battery thermal management device of claim 1, wherein the first thermal manager is further configured to allow the liquid working fluid from a powertrain cooling device and to heat the battery using a heat-exchanged liquid working fluid, and the second thermal manager is further configured to exchange heat between the liquid working fluid from the powertrain cooling device and an external gaseous working fluid and to heat the battery using the heat-exchanged external gaseous working fluid, in response to a temperature of the battery being less than a first temperature and an external temperature being greater than or equal to a second temperature.

14. The battery thermal management device of claim 1, wherein the first thermal manager is further configured to block the liquid working fluid from a powertrain cooling device and to cool the battery using a heat-exchanged liquid working fluid, and the second thermal manager is further configured to exchange heat between the gaseous working fluid cooled by a heating, ventilation, and air-conditioning (HVAC) device and the liquid working fluid and to cool the battery using the heat-exchanged gaseous working fluid cooled by the HVAC, in response to a temperature of the battery being greater than or equal to a first temperature and an acceleration or a brake signal indicating hill climbing, rapid acceleration, or rapid deceleration.

15. The battery thermal management device of claim 1, wherein the first thermal manager is further configured to block the liquid working fluid from a powertrain cooling device and to cool the battery by maximizing the use of a heat-exchanged liquid working fluid, and the second thermal manager is further configured to exchange heat between the gaseous working fluid cooled by a heating, ventilation, and air-conditioning (HVAC) and the liquid working fluid and to cool the battery by maximizing the use of the heat-exchanged gaseous working fluid cooled by the HVAC device, in response to a temperature of the battery being greater than or equal to a temperature.

16. The battery thermal management device of claim 9, wherein the portions of the battery with likelihood of being short-circuited comprise a bus bar, a tap portion of each battery cell of the battery, and a battery cell located in the middle of each battery module.

17. A battery thermal management method comprising:
exchanging heat between a liquid working fluid and a gaseous working fluid;
regulating a battery temperature using the heat-exchanged liquid working fluid; and
regulating the battery temperature using the heat-exchanged gaseous working fluid.

18. The battery thermal management method of claim 17, wherein the exchanging of heat between the liquid working fluid and the gaseous working fluid comprises blocking the liquid working fluid from a powertrain cooling device and exchanging heat between an external gaseous working fluid and the liquid working fluid, in response to a temperature of the battery being greater than or equal to a first temperature and less than a third temperature and an external temperature being less than a second temperature.

19. The battery thermal management method of claim 17, wherein the exchanging of heat between the liquid working fluid and the gaseous working fluid comprises blocking the liquid working fluid from a powertrain cooling device, and exchanging heat between the gaseous working fluid cooled by a heating, ventilation, and air-conditioning (HVAC) device and the liquid working fluid, in response to a temperature of the battery being greater than or equal to a first temperature and less than a third temperature and an external temperature being greater than or equal to a second temperature.

20. The battery thermal management method of claim 17, wherein the exchanging of heat between the liquid working fluid and the gaseous working fluid comprises allowing the liquid working fluid from a powertrain cooling device and exchanging heat between the gaseous working fluid heated by a heating, ventilation, and air-conditioning (HVAC) device and the liquid working fluid, in response to a temperature of the battery being less than a first temperature and an external temperature being less than a second temperature.

21. The battery thermal management method of claim 17, wherein the exchanging of heat between the liquid working fluid and the gaseous working fluid comprises allowing the liquid working fluid from a powertrain cooling device and exchanging heat between an external gaseous working fluid and the liquid working fluid, in response to a temperature of the battery being less than a first temperature and an external temperature is greater than or equal to a second temperature.

22. The battery thermal management method of claim 17, further comprising:
determining whether hill climbing, rapid acceleration, or rapid deceleration occurs, in response to a temperature of the battery being greater than or equal to a first temperature, and
wherein the exchanging of heat between the liquid working fluid and the gaseous working fluid comprises blocking the liquid working fluid from a powertrain cooling device and exchanging heat between the gaseous working fluid cooled by a heating, ventilation, and air-conditioning (HVAC) device and the liquid working fluid, in response to determining the occurrence of any one or any combination of hill climbing, rapid acceleration, or rapid deceleration.

23. The battery thermal management method of claim 17, wherein in response to a temperature of the battery being greater than or equal to a third temperature, the exchanging of heat between a liquid working fluid and a gaseous working fluid comprises blocking the liquid working fluid from a powertrain cooling device and exchanging heat between the gaseous working fluid cooled by a heating, ventilation, and air-conditioning (HVAC) device and the liquid working fluid,
the regulating of the battery temperature using the heat-exchanged liquid working fluid comprises cooling the battery by maximizing the use of the heat-exchanged liquid working fluid, and
the regulating of the battery temperature using the heat-exchanged gaseous working fluid comprises cooling the battery by maximizing the use of a heat-exchanged gaseous working fluid cooled by the HVAC device.
